(19) United States
(12) Patent Application Publication
(10) Pub. No.: US 2026/0186145 A1
(43) Pub. Date: Jul. 2, 2026

(54) ADJUSTING IMAGING SYSTEM DATA IN RESPONSE TO EDGE EFFECTS

(71) Applicant: SiLC Technologies, Inc., Monrovia, CA (US)

(72) Inventors: Siddhant Nadkarni, San Gabriel, CA (US); Cejo Lonappan, Monrovia, CA (US); Nirmal Chindhu Warke, Saratoga, CA (US); Prakash Koonath, La Crescenta, CA (US)

(21) Appl. No.: 19/540,570

(22) Filed: Feb. 13, 2026

Related U.S. Application Data
(63) Continuation of application No. 17/691,111, filed on Mar. 9, 2022, now abandoned.

(51) Int. Cl. G01S 17/89; G01S 17/58

(52) U.S. Cl. CPC G01S 17/89; G01S 17/58

(57) ABSTRACT

An imaging system generates a point cloud such that each point in the point cloud is associated with coordinates, a velocity, and a distance of the point from the imaging system. The system applies one or more velocity criteria to the velocities associated with at least a portion of the points. Additionally, the system flags a portion of a points as valid. The system also flags a second portion of the points as invalid in response to the results of applying the one or more velocity criteria to the velocities. The system performs calculations on the points in the point cloud such that data associated with the points flagged as invalid are excluded from the calculations but the data associated with the points flagged as valid are included in the calculations.

### RELATED APPLICATIONS

This application is a continuation of U.S. patent application Ser. No. 17/691,111, filed on Mar. 9, 2022, entitled “Adjusting Imaging System Data in Response to Edge Effects,” and incorporated herein in its entirety.

### FIELD

The invention relates to imaging systems. In particular, the invention relates to data refinement in imaging systems.

### BACKGROUND

LIDAR systems output a system output signal that is reflected by objects located outside of the LIDAR system. The reflected light returns to the LIDAR system as a system return signal. The LIDAR system includes electronics that use the system return signal to determine LIDAR data (radial velocity and/or distance between the LIDAR system and the objects) for a sample region that is illuminated by the system output signal.

In order for a LIDAR system to generate an image of a scene, the system output signal is scanned across the scene. During the scan, the LIDAR data is generated for multiple different sample regions within the scene. Each of the sample regions is illuminated for a regional time period in order to generate the LIDAR data for the sample region. However, the scanning of the system output signal continues during the regional time period. As a result, the system output signal can illuminate one object at the start of a regional time period and then move so the system output signal illuminates another object before the regional time period has expired. Changing the object that is illuminated during a regional time period is a source of edge effect errors in the LIDAR data. As a result, there is a need for LIDAR systems that can provide more reliable LIDAR data.

### SUMMARY

An imaging system generates a point cloud such that each point in the point cloud is associated with a velocity and a distance of the point from the imaging system. The system applies one or more velocity criteria to the velocities associated with at least a portion of the points. Additionally, the system flags a portion of a points as valid. The system also flags a second portion of the points as invalid in response to the results of applying the one or more velocity criteria to the velocities. The system performs calculations on the points in the point cloud such that data associated with the points flagged as invalid are excluded from the calculations but the data associated with the points flagged as valid are included in the calculations.

### BRIEF DESCRIPTION OF THE FIGURES

FIG. 1A is a topview of a schematic of a LIDAR system that includes or consists of a LIDAR chip that outputs a LIDAR output signal and receives a LIDAR input signal on a common waveguide.

FIG. 1B is a topview of a schematic of a LIDAR system that includes or consists of a LIDAR chip that outputs a LIDAR output signal and receives a LIDAR input signal on different waveguides.

FIG. 1C is a topview of a schematic of another embodiment of a LIDAR system that that includes or consists of a LIDAR chip that outputs a LIDAR output signal and receives multiple LIDAR input signals on different waveguides.

FIG. 2 is a topview of an example of a LIDAR adapter that is suitable for use with the LIDAR chip of FIG. 1B.

FIG. 3 is a topview of an example of a LIDAR adapter that is suitable for use with the LIDAR chip of FIG. 1C.

FIG. 4 is a topview of an example of a LIDAR system that includes the LIDAR chip of FIG. 1A and the LIDAR adapter of FIG. 2 on a common support.

FIG. 5A illustrates an example of a processing component suitable for use with the LIDAR systems.

FIG. 5B provides a schematic of electronics that are suitable for use with a processing component constructed according to FIG. 5A.

FIG. 5C is a graph of frequency versus time for a system output signal.

FIG. 5D is a diagram illustrating the field of view for a LIDAR system.

FIG. 5E illustrates objects in the field of view disclosed in the context of FIG. 5D.

FIG. 5F illustrates FIG. 5E modified so an edge in the field of view is on a single object.

FIG. 5G illustrates conversion of field locations in the field of view of FIG. 5F to field positions.

FIG. 6 illustrates a process flow for a suitable process of addressing edge effect errors.

FIG. 7 is a cross-section of portion of a LIDAR chip that includes a waveguide on a silicon-on-insulator platform.

### DESCRIPTION

A LIDAR system is configured to perform a field scan where multiple sample regions in a field of view are sequentially illuminated by a system output signal. The LIDAR system includes electronics that use light from the system output signal to generate LIDAR data results for the sample regions. Each of the LIDAR data results indicates a radial velocity and/or a distance between the LIDAR system and an object located outside of the LIDAR system and in the sample region illuminated by the system output signal that is associated with the LIDAR data.

The LIDAR system converts the LIDAR data results to a series of points within the field of view. The collection of points can serve as a point cloud. The inventors have unexpectedly found that points within the point cloud that result from edge error effects occur in spatial clusters and that the radial velocities associated with these spatial clusters have a large variation. In particular, the radial velocities associated with the clustered points tend to be at the high end and/or the low end of the possible radial velocity spectrum. The LIDAR system takes advantage of these features to remove at least a portion of the points that result from edge error effects from the point cloud and/or from the LIDAR data results. Excluding points that result from edge error effects from the LIDAR data results and/or a point cloud provides filtered LIDAR data results and/or a filtered point cloud that is a more accurate representation of the contents of the field of view. As a result, the LIDAR system can process the filtered LIDAR data results and/or a filtered point cloud rather than prior LIDAR data results to achieve more reliable LIDAR data results.

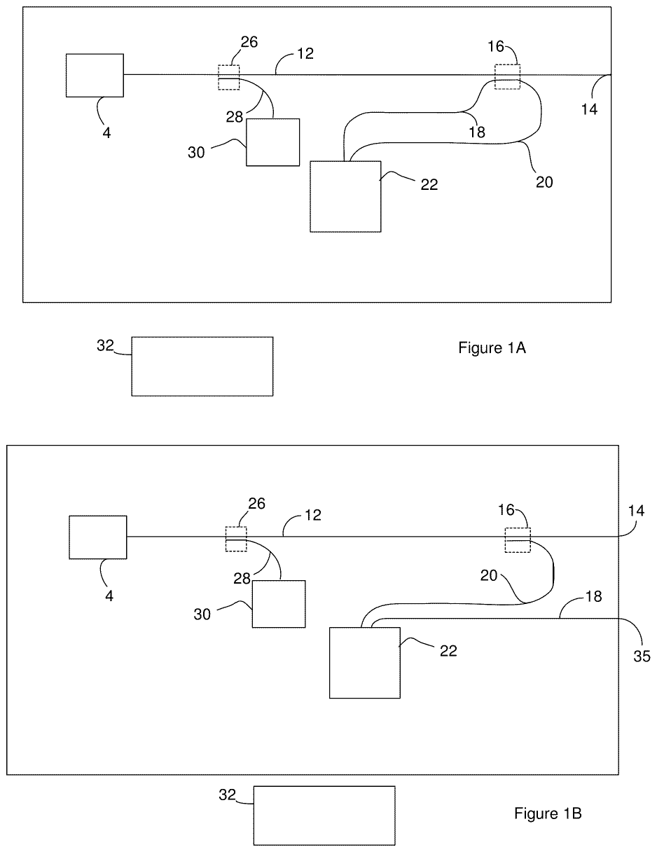

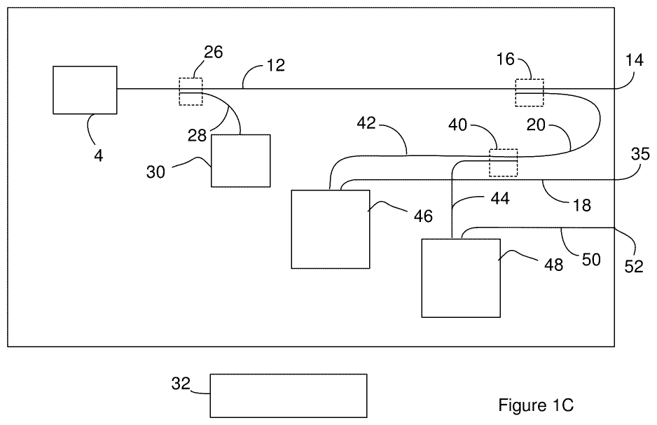

FIG. 1A is a topview of a schematic of a LIDAR chip that can serve as a LIDAR system or can be included in a LIDAR system that includes components in addition to the LIDAR chip. The LIDAR chip can include a Photonic Integrated Circuit (PIC) and can be a Photonic Integrated Circuit chip. The LIDAR chip includes a light source 4 that outputs a preliminary outgoing LIDAR signal. A suitable light source 4 includes, but is not limited to, semiconductor lasers such as External Cavity Lasers (ECLs), Distributed Feedback lasers (DFBs), Discrete Mode (DM) lasers and Distributed Bragg Reflector lasers (DBRs).

The LIDAR chip includes a utility waveguide 12 that receives an outgoing LIDAR signal from a light source 4. The utility waveguide 12 terminates at a facet 14 and carries the outgoing LIDAR signal to the facet 14. The facet 14 can be positioned such that the outgoing LIDAR signal traveling through the facet 14 exits the LIDAR chip and serves as a LIDAR output signal. For instance, the facet 14 can be positioned at an edge of the chip so the outgoing LIDAR signal traveling through the facet 14 exits the chip and serves as the LIDAR output signal. In some instances, the portion of the LIDAR output signal that has exited from the LIDAR chip can also be considered a system output signal. As an example, when the exit of the LIDAR output signal from the LIDAR chip is also an exit of the LIDAR output signal from the LIDAR system, the LIDAR output signal can also be considered a system output signal.

The LIDAR output signal travels away from the LIDAR system through free space in the environment and/or atmosphere in which the LIDAR system is positioned. The LIDAR output signal may be reflected by one or more objects in the path of the LIDAR output signal. When the LIDAR output signal is reflected, at least a portion of the reflected light travels back toward the LIDAR chip as a LIDAR input signal. In some instances, the LIDAR input signal can also be considered a system return signal. As an example, when the exit of the LIDAR output signal from the LIDAR chip is also an exit of the LIDAR output signal from the LIDAR system, the LIDAR input signal can also be considered a system return signal.

The LIDAR input signals can enter the utility waveguide 12 through the facet 14. The portion of the LIDAR input signal that enters the utility waveguide 12 serves as an incoming LIDAR signal. The utility waveguide 12 carries the incoming LIDAR signal to a splitter 16 that moves a portion of the outgoing LIDAR signal from the utility waveguide 12 onto a comparative waveguide 18 as a comparative signal. The comparative waveguide 18 carries the comparative signal to a processing component 22 for further processing. Although FIG. 1A illustrates a directional coupler operating as the splitter 16, other signal tapping components can be used as the splitter 16. Suitable splitters 16 include, but are not limited to, directional couplers, optical couplers, y-junctions, tapered couplers, and Multi-Mode Interference (MMI) devices.

The utility waveguide 12 also carrier the outgoing LIDAR signal to the splitter 16. The splitter 16 moves a portion of the outgoing LIDAR signal from the utility waveguide 12 onto a reference waveguide 20 as a reference signal. The reference waveguide 20 carries the reference signal to the processing component 22 for further processing.

The percentage of light transferred from the utility waveguide 12 by the splitter 16 can be fixed or substantially fixed. For instance, the splitter 16 can be configured such that the power of the reference signal transferred to the reference waveguide 20 is an outgoing percentage of the power of the outgoing LIDAR signal or such that the power of the comparative signal transferred to the comparative waveguide 18 is an incoming percentage of the power of the incoming LIDAR signal. In many splitters 16, such as directional couplers and multimode interferometers (MMIs), the outgoing percentage is equal or substantially equal to the incoming percentage. In some instances, the outgoing percentage is greater than 30%, 40%, or 49% and/or less than 51%, 60%, or 70% and/or the incoming percentage is greater than 30%, 40%, or 49% and/or less than 51%, 60%, or 70%. A splitter 16 such as a multimode interferometer (MMI) generally provides an outgoing percentage and an incoming percentage of 50% or about 50%. However, multimode interferometers (MMIs) can be easier to fabricate in platforms such as silicon-on-insulator platforms than some alternatives. In one example, the splitter 16 is a multimode interferometer (MMI) and the outgoing percentage and the incoming percentage are 50% or substantially 50%. As will be described in more detail below, the processing component 22 combines the comparative signal with the reference signal to form a composite signal that carries LIDAR data for a sample region on the field of view. Accordingly, the composite signal can be processed so as to extract LIDAR data (radial velocity and/or distance between a LIDAR system and an object external to the LIDAR system) for the sample region.

The LIDAR chip can include a control branch for controlling operation of the light source 4. The control branch includes a splitter 26 that moves a portion of the outgoing LIDAR signal from the utility waveguide 12 onto a control waveguide 28. The coupled portion of the outgoing LIDAR signal serves as a tapped signal. Although FIG. 1A illustrates a directional coupler operating as the splitter 26, other signal tapping components can be used as the splitter 26. Suitable splitters 26 include, but are not limited to, directional couplers, optical couplers, y-junctions, tapered couplers, and Multi-Mode Interference (MMI) devices.

The control waveguide 28 carries the tapped signal to control components 30. The control components can be in electrical communication with electronics 32. All or a portion of the control components can be included in the electronics 32. During operation, the electronics can employ output from the control components 30 in a control loop configured to control a process variable of one, two, or three loop controlled light signals selected from the group consisting of the tapped signal, the system output signal, and the outgoing LIDAR signal. Examples of the suitable process variables include the frequency of the loop controlled light signal and/or the phase of the loop controlled light signal.

The LIDAR system can be modified so the incoming LIDAR signal and the outgoing LIDAR signal can be carried on different waveguides. For instance, FIG. 1B is a topview of the LIDAR chip of FIG. 1A modified such that the incoming LIDAR signal and the outgoing LIDAR signal are carried on different waveguides. The outgoing LIDAR signal exits the LIDAR chip through the facet 14 and serves as the LIDAR output signal. When light from the LIDAR output signal is reflected by an object external to the LIDAR system, at least a portion of the reflected light returns to the LIDAR chip as a first LIDAR input signal. The first LIDAR input signals enters the comparative waveguide 18 through a facet 35 and serves as the comparative signal. The comparative waveguide 18 carries the comparative signal to a processing component 22 for further processing. As described in the context of FIG. 1A, the reference waveguide 20 carries the reference signal to the processing component 22 for further processing. As will be described in more detail below, the processing component 22 combines the comparative signal with the reference signal to form a composite signal that carries LIDAR data for a sample region on the field of view.

The LIDAR chips can be modified to receive multiple LIDAR input signals. For instance, FIG. 1C illustrates the LIDAR chip of FIG. 1B modified to receive two LIDAR input signals. A splitter 40 is configured to place a portion of the reference signal carried on the reference waveguide 20 on a first reference waveguide 42 and another portion of the reference signal on a second reference waveguide 44. Accordingly, the first reference waveguide 42 carries a first reference signal and the second reference waveguide 44 carries a second reference signal. The first reference waveguide 42 carries the first reference signal to a first processing component 46 and the second reference waveguide 44 carries the second reference signal to a second processing component 48. Examples of suitable splitters 40 include, but are not limited to, y-junctions, optical couplers, and multi-mode interference couplers (MMIs).

The outgoing LIDAR signal exits the LIDAR chip through the facet 14 and serves as the LIDAR output signal. When light from the LIDAR output signal is reflected by one or more object located external to the LIDAR system, at least a portion of the reflected light returns to the LIDAR chip as a first LIDAR input signal. The first LIDAR input signals enters the comparative waveguide 18 through the facet 35 and serves as a first comparative signal. The comparative waveguide 18 carries the first comparative signal to a first processing component 46 for further processing.

Additionally, when light from the LIDAR output signal is reflected by one or more object located external to the LIDAR system, at least a portion of the reflected signal returns to the LIDAR chip as a second LIDAR input signal. The second LIDAR input signals enters a second comparative waveguide 50 through a facet 52 and serves as a second comparative signal carried by the second comparative waveguide 50. The second comparative waveguide 50 carries the second comparative signal to a second processing component 48 for further processing.

Although the light source 4 is shown as being positioned on the LIDAR chip, the light source 4 can be located off the LIDAR chip. For instance, the utility waveguide 12 can terminate at a second facet through which the outgoing LIDAR signal can enter the utility waveguide 12 from a light source 4 located off the LIDAR chip.

In some instances, a LIDAR chip constructed according to FIG. 1B or FIG. 1C is used in conjunction with a LIDAR adapter. In some instances, the LIDAR adapter can be physically optically positioned between the LIDAR chip and the one or more reflecting objects and/or the field of view in that an optical path that the first LIDAR input signal(s) and/or the LIDAR output signal travels from the LIDAR chip to the field of view passes through the LIDAR adapter. Additionally, the LIDAR adapter can be configured to operate on the first LIDAR input signal and the LIDAR output signal such that the first LIDAR input signal and the LIDAR output signal travel on different optical pathways between the LIDAR adapter and the LIDAR chip but on the same optical pathway between the LIDAR adapter and a reflecting object in the field of view.

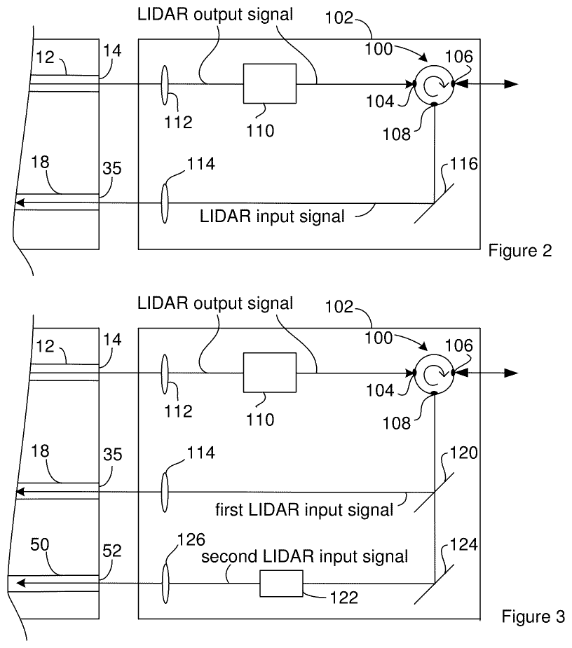

An example of a LIDAR adapter that is suitable for use with the LIDAR chip of FIG. 1B is illustrated in FIG. 2. The LIDAR adapter includes multiple components positioned on a base. For instance, the LIDAR adapter includes a circulator 100 positioned on a base 102. The illustrated optical circulator 100 includes three ports and is configured such that light entering one port exits from the next port. For instance, the illustrated optical circulator includes a first port 104, a second port 106, and a third port 108. The LIDAR output signal enters the first port 104 from the utility waveguide 12 of the LIDAR chip and exits from the second port 106.

The LIDAR adapter can be configured such that the output of the LIDAR output signal from the second port 106 can also serve as the output of the LIDAR output signal from the LIDAR adapter and accordingly from the LIDAR system. As a result, the LIDAR output signal can be output from the LIDAR adapter such that the LIDAR output signal is traveling toward a sample region in the field of view. Accordingly, in some instances, the portion of the LIDAR output signal that has exited from the LIDAR adapter can also be considered the system output signal. As an example, when the exit of the LIDAR output signal from the LIDAR adapter is also an exit of the LIDAR output signal from the LIDAR system, the LIDAR output signal can also be considered a system output signal.

The LIDAR output signal output from the LIDAR adapter includes, consists of, or consists essentially of light from the LIDAR output signal received from the LIDAR chip. Accordingly, the LIDAR output signal output from the LIDAR adapter may be the same or substantially the same as the LIDAR output signal received from the LIDAR chip. However, there may be differences between the LIDAR output signal output from the LIDAR adapter and the LIDAR output signal received from the LIDAR chip. For instance, the LIDAR output signal can experience optical loss as it travels through the LIDAR adapter and/or the LIDAR adapter can optionally include an amplifier configured to amplify the LIDAR output signal as it travels through the LIDAR adapter.

When one or more objects in the sample region reflect the LIDAR output signal, at least a portion of the reflected light travels back to the circulator 100 as a system return signal. The system return signal enters the circulator 100 through the second port 106. FIG. 2 illustrates the LIDAR output signal and the system return signal traveling between the LIDAR adapter and the sample region along the same optical path.

The system return signal exits the circulator 100 through the third port 108 and is directed to the comparative waveguide 18 on the LIDAR chip. Accordingly, all or a portion of the system return signal can serve as the first LIDAR input signal and the first LIDAR input signal includes or consists of light from the system return signal. Accordingly, the LIDAR output signal and the first LIDAR input signal travel between the LIDAR adapter and the LIDAR chip along different optical paths.

As is evident from FIG. 2, the LIDAR adapter can include optical components in addition to the circulator 100. For instance, the LIDAR adapter can include components for directing and controlling the optical path of the LIDAR output signal and the system return signal. As an example, the adapter of FIG. 2 includes an optional amplifier 110 positioned so as to receive and amplify the LIDAR output signal before the LIDAR output signal enters the circulator 100. The amplifier 110 can be operated by the electronics 32 allowing the electronics 32 to control the power of the LIDAR output signal.

FIG. 2 also illustrates the LIDAR adapter including an optional first lens 112 and an optional second lens 114. The first lens 112 can be configured to couple the LIDAR output signal to a desired location. In some instances, the first lens 112 is configured to focus or collimate the LIDAR output signal at a desired location. In one example, the first lens 112 is configured to couple the LIDAR output signal on the first port 104 when the LIDAR adapter does not include an amplifier 110. As another example, when the LIDAR adapter includes an amplifier 110, the first lens 112 can be configured to couple the LIDAR output signal on the entry port to the amplifier 110. The second lens 114 can be configured to couple the LIDAR output signal at a desired location. In some instances, the second lens 114 is configured to focus or collimate the LIDAR output signal at a desired location. For instance, the second lens 114 can be configured to couple the LIDAR output signal the on the facet 35 of the comparative waveguide 18.

The LIDAR adapter can also include one or more direction changing components such as mirrors. FIG. 2 illustrates the LIDAR adapter including a mirror as a direction-changing component 116 that redirects the system return signal from the circulator 100 to the facet 20 of the comparative waveguide 18.

The LIDAR chips include one or more waveguides that constrains the optical path of one or more light signals. While the LIDAR adapter can include waveguides, the optical path that the system return signal and the LIDAR output signal travel between components on the LIDAR adapter and/or between the LIDAR chip and a component on the LIDAR adapter can be free space. For instance, the system return signal and/or the LIDAR output signal can travel through the environment and/or atmosphere in which the LIDAR chip, the LIDAR adapter, and/or the base 102 is positioned when traveling between the different components on the LIDAR adapter and/or between a component on the LIDAR adapter and the LIDAR chip. As a result, optical components such as lenses and direction changing components can be employed to control the characteristics of the optical path traveled by the system return signal and the LIDAR output signal on, to, and from the LIDAR adapter.

Suitable bases 102 for the LIDAR adapter include, but are not limited to, substrates, platforms, and plates. Suitable substrates include, but are not limited to, glass, silicon, and ceramics. The components can be discrete components that are attached to the substrate. Suitable techniques for attaching discrete components to the base 102 include, but are not limited to, epoxy, solder, and mechanical clamping. In one example, one or more of the components are integrated components and the remaining components are discrete components. In another example, the LIDAR adapter includes one or more integrated amplifiers and the remaining components are discrete components.

The LIDAR system can be configured to compensate for polarization. Light from a laser source is typically linearly polarized and hence the LIDAR output signal is also typically linearly polarized. Reflection from an object may change the angle of polarization of the returned light. Accordingly, the system return signal can include light of different linear polarization states. For instance, a first portion of a system return signal can include light of a first linear polarization state and a second portion of a system return signal can include light of a second linear polarization state. The intensity of the resulting composite signals is proportional to the square of the cosine of the angle between the comparative and reference signal polarization fields. If the angle is 90 degrees, the LIDAR data can be lost in the resulting composite signal. However, the LIDAR system can be modified to compensate for changes in polarization state of the LIDAR output signal.

FIG. 3 illustrates the LIDAR system of FIG. 3 modified such that the LIDAR adapter is suitable for use with the LIDAR chip of FIG. 1C. The LIDAR adapter includes a beamsplitter 120 that receives the system return signal from the circulator 100. The beamsplitter 120 splits the system return signal into a first portion of the system return signal and a second portion of the system return signal. Suitable beamsplitters include, but are not limited to, Wollaston prisms, and MEMS-based beamsplitters.

The first portion of the system return signal is directed to the comparative waveguide 18 on the LIDAR chip and serves as the first LIDAR input signal described in the context of FIG. 1C. The second portion of the system return signal is directed a polarization rotator 122. The polarization rotator 122 outputs a second LIDAR input signal that is directed to the second input waveguide 76 on the LIDAR chip and serves as the second LIDAR input signal.

The beamsplitter 120 can be a polarizing beam splitter. One example of a polarizing beamsplitter is constructed such that the first portion of the system return signal has a first polarization state but does not have or does not substantially have a second polarization state and the second portion of the system return signal has a second polarization state but does not have or does not substantially have the first polarization state. The first polarization state and the second polarization state can be linear polarization states and the second polarization state is different from the first polarization state. For instance, the first polarization state can be TE and the second polarization state can be TM or the first polarization state can be TM and the second polarization state can be TE. In some instances, the laser source can linearly polarized such that the LIDAR output signal has the first polarization state. Suitable beamsplitters include, but are not limited to, Wollaston prisms, and MEMs-based polarizing beamsplitters.

A polarization rotator can be configured to change the polarization state of the first portion of the system return signal and/or the second portion of the system return signal. For instance, the polarization rotator 122 shown in FIG. 3 can be configured to change the polarization state of the second portion of the system return signal from the second polarization state to the first polarization state. As a result, the second LIDAR input signal has the first polarization state but does not have or does not substantially have the second polarization state. Accordingly, the first LIDAR input signal and the second LIDAR input signal each have the same polarization state (the first polarization state in this example). Despite carrying light of the same polarization state, the first LIDAR input signal and the second LIDAR input signal are associated with different polarization states as a result of the use of the polarizing beamsplitter. For instance, the first LIDAR input signal carries the light reflected with the first polarization state and the second LIDAR input signal carries the light reflected with the second polarization state. As a result, the first LIDAR input signal is associated with the first polarization state and the second LIDAR input signal is associated with the second polarization state.

Since the first LIDAR input signal and the second LIDAR carry light of the same polarization state, the comparative signals that result from the first LIDAR input signal have the same polarization angle as the comparative signals that result from the second LIDAR input signal.

Suitable polarization rotators include, but are not limited to, rotation of polarization-maintaining fibers, Faraday rotators, half-wave plates, MEMs-based polarization rotators and integrated optical polarization rotators using asymmetric y-branches, Mach-Zehnder interferometers and multi-mode interference couplers.

Since the outgoing LIDAR signal is linearly polarized, the first reference signals can have the same linear polarization state as the second reference signals. Additionally, the components on the LIDAR adapter can be selected such that the first reference signals, the second reference signals, the comparative signals and the second comparative signals each have the same polarization state. In the example disclosed in the context of FIG. 3, the first comparative signals, the second comparative signals, the first reference signals, and the second reference signals can each have light of the first polarization state.

As a result of the above configuration, first composite signals generated by the first processing component 46 and second composite signals generated by the second processing component 48 each results from combining a reference signal and a comparative signal of the same polarization state and will accordingly provide the desired beating between the reference signal and the comparative signal. For instance, the composite signal results from combining a first reference signal and a first comparative signal of the first polarization state and excludes or substantially excludes light of the second polarization state or the composite signal results from combining a first reference signal and a first comparative signal of the second polarization state and excludes or substantially excludes light of the first polarization state. Similarly, the second composite signal includes a second reference signal and a second comparative signal of the same polarization state will accordingly provide the desired beating between the reference signal and the comparative signal. For instance, the second composite signal results from combining a second reference signal and a second comparative signal of the first polarization state and excludes or substantially excludes light of the second polarization state or the second composite signal results from combining a second reference signal and a second comparative signal of the second polarization state and excludes or substantially excludes light of the first polarization state.

The above configuration results in the LIDAR data for a single sample region in the field of view being generated from multiple different composite signals (i.e. first composite signals and the second composite signal) from the sample region. In some instances, determining the LIDAR data for the sample region includes the electronics combining the LIDAR data from different composite signals (i.e. the composite signals and the second composite signal). Combining the LIDAR data can include taking an average, median, or mode of the LIDAR data generated from the different composite signals. For instance, the electronics can average the distance between the LIDAR system and the reflecting object determined from the composite signal with the distance determined from the second composite signal and/or the electronics can average the radial velocity between the LIDAR system and the reflecting object determined from the composite signal with the radial velocity determined from the second composite signal.

In some instances, determining the LIDAR data for a sample region includes the electronics identifying one or more composite signals (i.e. the composite signal and/or the second composite signal) as the source of the LIDAR data that is most represents reality (the representative LIDAR data). The electronics can then use the LIDAR data from the identified composite signal as the representative LIDAR data to be used for additional processing. For instance, the electronics can identify the signal (composite signal or the second composite signal) with the larger amplitude as having the representative LIDAR data and can use the LIDAR data from the identified signal for further processing by the LIDAR system. In some instances, the electronics combine identifying the composite signal with the representative LIDAR data with combining LIDAR data from different LIDAR signals. For instance, the electronics can identify each of the composite signals with an amplitude above an amplitude threshold as having representative LIDAR data and when more than two composite signals are identified as having representative LIDAR data, the electronics can combine the LIDAR data from each of identified composite signals. When one composite signal is identified as having representative LIDAR data, the electronics can use the LIDAR data from that composite signal as the representative LIDAR data. When none of the composite signals is identified as having representative LIDAR data, the electronics can discard the LIDAR data for the sample region associated with those composite signals.

Although FIG. 3 is described in the context of components being arranged such that the first comparative signals, the second comparative signals, the first reference signals, and the second reference signals each have the first polarization state, other configurations of the components in FIG. 3 can arranged such that the composite signals result from combining a reference signal and a comparative signal of the same linear polarization state and the second composite signal results from combining a reference signal and a comparative signal of the same linear polarization state. For instance, the beamsplitter 120 can be constructed such that the second portion of the system return signal has the first polarization state and the first portion of the system return signal has the second polarization state, the polarization rotator receives the first portion of the system return signal, and the outgoing LIDAR signal can have the second polarization state. In this example, the first LIDAR input signal and the second LIDAR input signal each has the second polarization state.

The above system configurations result in the first portion of the system return signal and the second portion of the system return signal being directed into different composite signals. As a result, since the first portion of the system return signal and the second portion of the system return signal are each associated with a different polarization state but electronics can process each of the composite signals, the LIDAR system compensates for changes in the polarization state of the LIDAR output signal in response to reflection of the LIDAR output signal.

The LIDAR adapter of FIG. 3 can include additional optical components including passive optical components. For instance, the LIDAR adapter can include an optional third lens 126. The third lens 126 can be configured to couple the second LIDAR output signal at a desired location. In some instances, the third lens 126 focuses or collimates the second LIDAR output signal at a desired location. For instance, the third lens 126 can be configured to focus or collimate the second LIDAR output signal on the facet 52 of the second comparative waveguide 50. The LIDAR adapter also includes one or more direction changing components 124 such as mirrors and prisms. FIG. 3 illustrates the LIDAR adapter including a mirror as a direction changing component 124 that redirects the second portion of the system return signal from the circulator 100 to the facet 52 of the second comparative waveguide 50 and/or to the third lens 126.

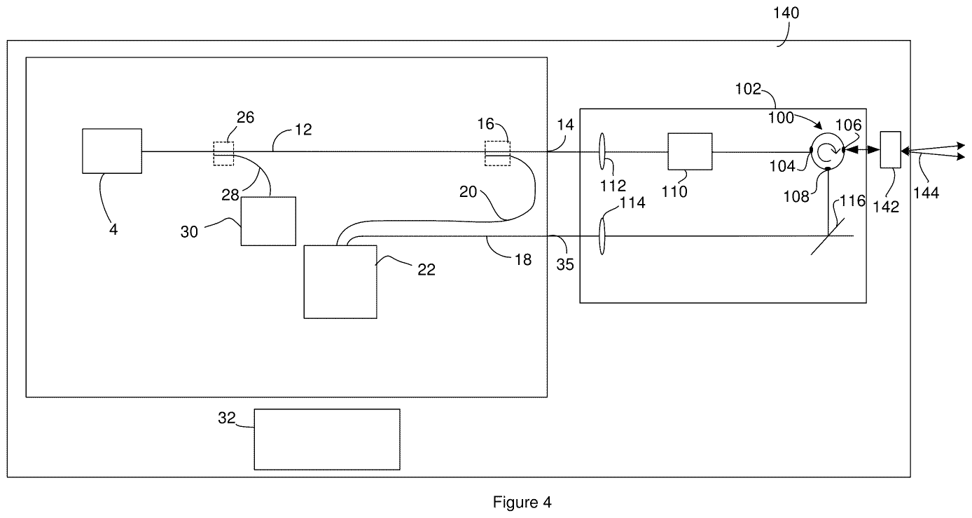

When the LIDAR system includes a LIDAR chip and a LIDAR adapter, the LIDAR chip, electronics, and the LIDAR adapter can be positioned on a common mount. Suitable common mounts include, but are not limited to, glass plates, metal plates, silicon plates and ceramic plates. As an example, FIG. 4 is a topview of a LIDAR system that includes the LIDAR chip and electronics 32 of FIG. 1A and the LIDAR adapter of FIG. 2 on a common support 140. Although the electronics 32 are illustrated as being located on the common support, all or a portion of the electronics can be located off the common support. When the light source 4 is located off the LIDAR chip, the light source can be located on the common support 140 or off of the common support 140. Suitable approaches for mounting the LIDAR chip, electronics, and/or the LIDAR adapter on the common support include, but are not limited to, epoxy, solder, and mechanical clamping.

The LIDAR systems can include components including additional passive and/or active optical components. For instance, the LIDAR system can include one or more components that receive the LIDAR output signal from the LIDAR chip or from the LIDAR adapter. The portion of the LIDAR output signal that exits from the one or more components can serve as the system output signal. As an example, the LIDAR system can include one or more beam steering components that receive the LIDAR output signal from the LIDAR chip or from the LIDAR adapter and that output all or a fraction of the LIDAR output signal that serves as the system output signal. For instance, FIG. 4 illustrates a beam steering component 142 that receive a LIDAR output signal from the LIDAR adapter. Although FIG. 4 shows the beam steering component positioned on the common support 140, the beam steering component can be positioned on the LIDAR chip, on the LIDAR adapter, off the LIDAR chip, or off the common support 140. Suitable beam steering components include, but are not limited to, movable mirrors, MEMS mirrors, optical phased arrays (OPAs), and actuators that move the LIDAR chip, LIDAR adapter, and/or common support.

The electronics can operate the one or more beam steering component 142 so as to steer the system output signal to different sample regions 144. The sample regions can extend away from the LIDAR system to a maximum distance for which the LIDAR system is configured to provide reliable LIDAR data. The sample regions can be stitched together to define the field of view. For instance, the field of view of for the LIDAR system includes or consists of the space occupied by the combination of the sample regions.

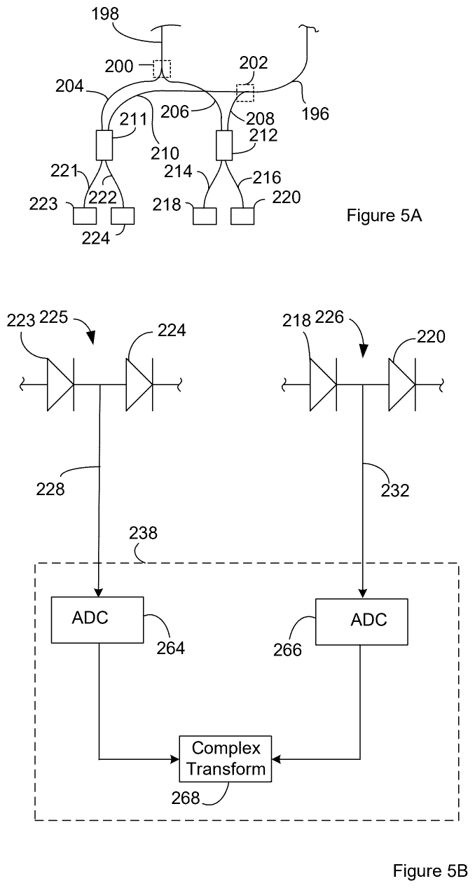

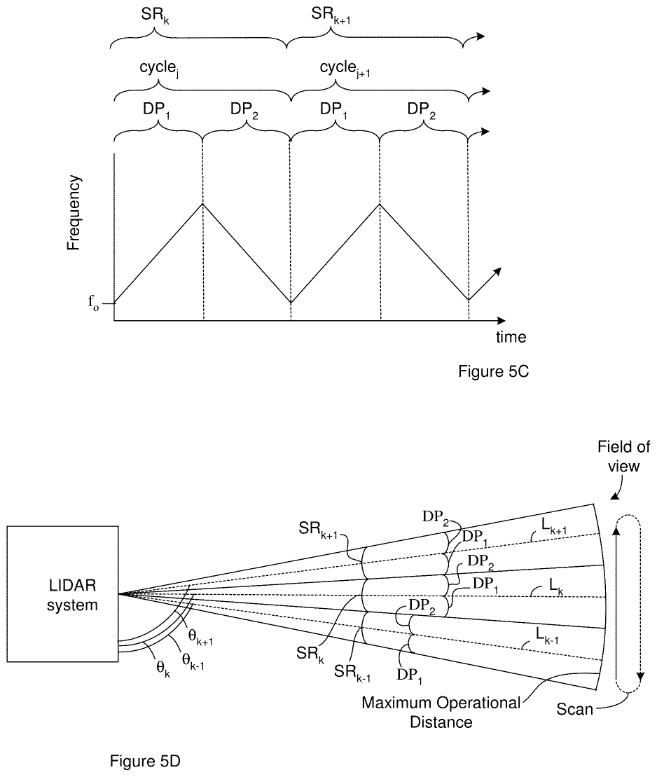

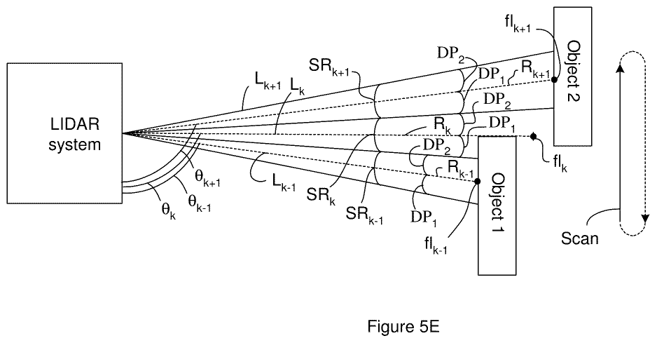

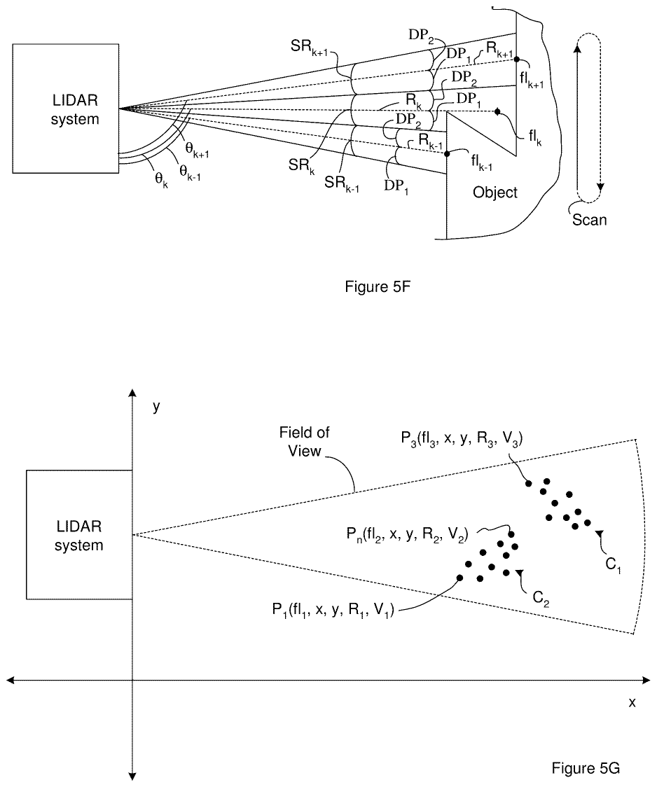

FIG. 5A through FIG. 5C illustrate an example of a suitable processing component for use as all or a fraction of the processing components selected from the group consisting of the processing component 22, the first processing component 46 and the second processing component 48. The processing component receives a comparative signal from a comparative waveguide 196 and a reference signal from a reference waveguide 198. The comparative waveguide 18 and the reference waveguide 20 shown in FIG. 1A and FIG. 1B can serve as the comparative waveguide 196 and the reference waveguide 198, the comparative waveguide 18 and the first reference waveguide 42 shown in FIG. 1C can serve as the comparative waveguide 196 and the reference waveguide 198, or the second comparative waveguide 50 and the second reference waveguide 44 shown in FIG. 1C can serve as the comparative waveguide 196 and the reference waveguide 198.

The processing component includes a second splitter 200 that divides the comparative signal carried on the comparative waveguide 196 onto a first comparative waveguide 204 and a second comparative waveguide 206. The first comparative waveguide 204 carries a first portion of the comparative signal to the light-combining component 211. The second comparative waveguide 208 carries a second portion of the comparative signal to the second light-combining component 212.

The processing component includes a first splitter 202 that divides the reference signal carried on the reference waveguide 198 onto a first reference waveguide 204 and a second reference waveguide 206. The first reference waveguide 204 carries a first portion of the reference signal to the light-combining component 211. The second reference waveguide 208 carries a second portion of the reference signal to the second light-combining component 212.

The second light-combining component 212 combines the second portion of the comparative signal and the second portion of the reference signal into a second composite signal. Due to the difference in frequencies between the second portion of the comparative signal and the second portion of the reference signal, the second composite signal is beating between the second portion of the comparative signal and the second portion of the reference signal.

The second light-combining component 212 also splits the resulting second composite signal onto a first auxiliary detector waveguide 214 and a second auxiliary detector waveguide 216. The first auxiliary detector waveguide 214 carries a first portion of the second composite signal to a first auxiliary light sensor 218 that converts the first portion of the second composite signal to a first auxiliary electrical signal. The second auxiliary detector waveguide 216 carries a second portion of the second composite signal to a second auxiliary light sensor 220 that converts the second portion of the second composite signal to a second auxiliary electrical signal. Examples of suitable light sensors include germanium photodiodes (PDs), and avalanche photodiodes (APDs).

In some instances, the second light-combining component 212 splits the second composite signal such that the portion of the comparative signal (i.e. the portion of the second portion of the comparative signal) included in the first portion of the second composite signal is phase shifted by 180° relative to the portion of the comparative signal (i.e. the portion of the second portion of the comparative signal) in the second portion of the second composite signal but the portion of the reference signal (i.e. the portion of the second portion of the reference signal) in the second portion of the second composite signal is not phase shifted relative to the portion of the reference signal (i.e. the portion of the second portion of the reference signal) in the first portion of the second composite signal. Alternately, the second light-combining component 212 splits the second composite signal such that the portion of the reference signal (i.e. the portion of the second portion of the reference signal) in the first portion of the second composite signal is phase shifted by 180° relative to the portion of the reference signal (i.e. the portion of the second portion of the reference signal) in the second portion of the second composite signal but the portion of the comparative signal (i.e. the portion of the second portion of the comparative signal) in the first portion of the second composite signal is not phase shifted relative to the portion of the comparative signal (i.e. the portion of the second portion of the comparative signal) in the second portion of the second composite signal. Examples of suitable light sensors include germanium photodiodes (PDs), and avalanche photodiodes (APDs).

The first light-combining component 211 combines the first portion of the comparative signal and the first portion of the reference signal into a first composite signal. Due to the difference in frequencies between the first portion of the comparative signal and the first portion of the reference signal, the first composite signal is beating between the first portion of the comparative signal and the first portion of the reference signal.

The first light-combining component 211 also splits the first composite signal onto a first detector waveguide 221 and a second detector waveguide 222. The first detector waveguide 221 carries a first portion of the first composite signal to a first light sensor 223 that converts the first portion of the second composite signal to a first electrical signal. The second detector waveguide 222 carries a second portion of the second composite signal to a second light sensor 224 that converts the second portion of the second composite signal to a second electrical signal. Examples of suitable light sensors include germanium photodiodes (PDs), and avalanche photodiodes (APDs).

In some instances, the light-combining component 211 splits the first composite signal such that the portion of the comparative signal (i.e. the portion of the first portion of the comparative signal) included in the first portion of the composite signal is phase shifted by 180° relative to the portion of the comparative signal (i.e. the portion of the first portion of the comparative signal) in the second portion of the composite signal but the portion of the reference signal (i.e. the portion of the first portion of the reference signal) in the first portion of the composite signal is not phase shifted relative to the portion of the reference signal (i.e. the portion of the first portion of the reference signal) in the second portion of the composite signal. Alternately, the light-combining component 211 splits the composite signal such that the portion of the reference signal (i.e. the portion of the first portion of the reference signal) in the first portion of the composite signal is phase shifted by 180° relative to the portion of the reference signal (i.e. the portion of the first portion of the reference signal) in the second portion of the composite signal but the portion of the comparative signal (i.e. the portion of the first portion of the comparative signal) in the first portion of the composite signal is not phase shifted relative to the portion of the comparative signal (i.e. the portion of the first portion of the comparative signal) in the second portion of the composite signal.

When the second light-combining component 212 splits the second composite signal such that the portion of the comparative signal in the first portion of the second composite signal is phase shifted by 180° relative to the portion of the comparative signal in the second portion of the second composite signal, the light-combining component 211 also splits the composite signal such that the portion of the comparative signal in the first portion of the composite signal is phase shifted by 180° relative to the portion of the comparative signal in the second portion of the composite signal. When the second light-combining component 212 splits the second composite signal such that the portion of the reference signal in the first portion of the second composite signal is phase shifted by 180° relative to the portion of the reference signal in the second portion of the second composite signal, the light-combining component 211 also splits the composite signal such that the portion of the reference signal in the first portion of the composite signal is phase shifted by 180° relative to the portion of the reference signal in the second portion of the composite signal.

The first reference waveguide 210 and the second reference waveguide 208 are constructed to provide a phase shift between the first portion of the reference signal and the second portion of the reference signal. For instance, the first reference waveguide 210 and the second reference waveguide 208 can be constructed so as to provide a 90 degree phase shift between the first portion of the reference signal and the second portion of the reference signal. As an example, one reference signal portion can be an in-phase component and the other a quadrature component. Accordingly, one of the reference signal portions can be a sinusoidal function and the other reference signal portion can be a cosine function. In one example, the first reference waveguide 210 and the second reference waveguide 208 are constructed such that the first reference signal portion is a cosine function and the second reference signal portion is a sine function. Accordingly, the portion of the reference signal in the second composite signal is phase shifted relative to the portion of the reference signal in the first composite signal, however, the portion of the comparative signal in the first composite signal is not phase shifted relative to the portion of the comparative signal in the second composite signal.

The first light sensor 223 and the second light sensor 224 can be connected as a balanced detector and the first auxiliary light sensor 218 and the second auxiliary light sensor 220 can also be connected as a balanced detector. For instance, FIG. 5B provides a schematic of the relationship between the electronics, the first light sensor 223, the second light sensor 224, the first auxiliary light sensor 218, and the second auxiliary light sensor 220. The symbol for a photodiode is used to represent the first light sensor 223, the second light sensor 224, the first auxiliary light sensor 218, and the second auxiliary light sensor 220 but one or more of these sensors can have other constructions. In some instances, all of the components illustrated in the schematic of FIG. 5B are included on the LIDAR chip. In some instances, the components illustrated in the schematic of FIG. 5B are distributed between the LIDAR chip and electronics located off of the LIDAR chip.

The electronics connect the first light sensor 223 and the second light sensor 224 as a first balanced detector 225 and the first auxiliary light sensor 218 and the second auxiliary light sensor 220 as a second balanced detector 226. In particular, the first light sensor 223 and the second light sensor 224 are connected in series. Additionally, the first auxiliary light sensor 218 and the second auxiliary light sensor 220 are connected in series. The serial connection in the first balanced detector is in communication with a first data line 228 that carries the output from the first balanced detector as a first data signal. The serial connection in the second balanced detector is in communication with a second data line 232 that carries the output from the second balanced detector as a second data signal. The first data signal is an electrical representation of the first composite signal and the second data signal is an electrical representation of the second composite signal. Accordingly, the first data signal includes a contribution from a first waveform and a second waveform and the second data signal is a composite of the first waveform and the second waveform. The portion of the first waveform in the first data signal is phase-shifted relative to the portion of the first waveform in the first data signal but the portion of the second waveform in the first data signal being in-phase relative to the portion of the second waveform in the first data signal. For instance, the second data signal includes a portion of the reference signal that is phase shifted relative to a different portion of the reference signal that is included the first data signal. Additionally, the second data signal includes a portion of the comparative signal that is in-phase with a different portion of the comparative signal that is included in the first data signal. The first data signal and the second data signal are beating as a result of the beating between the comparative signal and the reference signal, i.e. the beating in the first composite signal and in the second composite signal.

The electronics 32 includes a transform mechanism 238 configured to perform a mathematical transform on the first data signal and the second data signal. For instance, the mathematical transform can be a complex Fourier transform with the first data signal and the second data signal as inputs. Since the first data signal is an in-phase component and the second data signal its quadrature component, the first data signal and the second data signal together act as a complex data signal where the first data signal is the real component and the second data signal is the imaginary component of the input.

The transform mechanism 238 includes a first Analog-to-Digital Converter (ADC) 264 that receives the first data signal from the first data line 228. The first Analog-to-Digital Converter (ADC) 264 converts the first data signal from an analog form to a digital form and outputs a first digital data signal. The transform mechanism 238 includes a second Analog-to-Digital Converter (ADC) 266 that receives the second data signal from the second data line 232. The second Analog-to-Digital Converter (ADC) 266 converts the second data signal from an analog form to a digital form and outputs a second digital data signal. The first digital data signal is a digital representation of the first data signal and the second digital data signal is a digital representation of the second data signal. Accordingly, the first digital data signal and the second digital data signal act together as a complex signal where the first digital data signal acts as the real component of the complex signal and the second digital data signal acts as the imaginary component of the complex data signal.

The transform mechanism 238 includes a transform component 268 that receives the complex data signal. For instance, the transform component 268 receives the first digital data signal from the first Analog-to-Digital Converter (ADC) 264 as an input and also receives the second digital data signal from the second Analog-to-Digital Converter (ADC) 266 as an input. The transform component 268 can be configured to perform a mathematical transform on the complex signal so as to convert from the time domain to the frequency domain. The mathematical transform can be a complex transform such as a complex Fast Fourier Transform (FFT). A complex transform such as a complex Fast Fourier Transform (FFT) provides an unambiguous solution for the shift in frequency of LIDAR input signal relative to the LIDAR output signal that is caused by the radial velocity between the reflecting object and the LIDAR chip. The electronics use the one or more frequency peaks output from the transform component 268 for further processing to generate the LIDAR data (distance and/or radial velocity between the reflecting object and the LIDAR chip or LIDAR system). The transform component 268 can execute the attributed functions using firmware, hardware or software or a combination thereof.

Although FIG. 5A illustrates light-combining components that combine a portion of the reference signal with a portion of the comparative signal, the processing component can include a single light-combining component that combines the reference signal with the comparative signal so as to form a composite signal. As a result, at least a portion of the reference signal and at least a portion of the comparative signal can be combined to form a composite signal. The combined portion of the reference signal can be the entire reference signal or a fraction of the reference signal and the combined portion of the comparative signal can be the entire comparative signal or a fraction of the comparative signal.

The electronics tune the frequency of the system output signal over time. The system output signal has a frequency versus time pattern with a repeated cycle. FIG. 5C shows an example of a suitable frequency versus time pattern for the system output signal. The base frequency of the system output signal (fₒ) can be the frequency of the system output signal at the start of a cycle.

FIG. 5C shows frequency versus time for a sequence of two cycles labeled cycleⱼ and cycleⱼ₊₁. In some instances, the frequency versus time pattern is repeated in each cycle as shown in FIG. 5C. The illustrated cycles do not include re-location periods and/or re-location periods are not located between cycles. As a result, FIG. 5C illustrates the results for a continuous scan.

Each cycle includes M data periods that are each associated with a period index m and are labeled DPₘ. In the example of FIG. 5C, each cycle includes three data periods labeled DPₘ with m=1 and 2. In some instances, the frequency versus time pattern is the same for the data periods that correspond to each other in different cycles as is shown in FIG. 5C. Corresponding data periods are data periods with the same period index. As a result, each data period DP₁ can be considered corresponding data periods and the associated frequency versus time patterns are the same in FIG. 5C. At the end of a cycle, the electronics return the frequency to the same frequency level at which it started the previous cycle.

During the data period DPₘ, the electronics operate the light source such that the frequency of the system output signal changes at a linear rate αₘ (the chirp rate). In FIG. 5C, α₂=−α₁.

FIG. 5C labels sample regions that are each associated with a sample region index k and are labeled SRₖ. FIG. 5C labels sample regions SRₖ₋₁ through SRₖ₊₁. Each sample region is illuminated with the system output signal during the data periods that FIG. 5C shows as associated with the sample region. For instance, sample region SRₖ₊₁ is illuminated with the system output signal during the data period labeled DP₂ within cycle j+1 and the data period labeled DP₁ within cycle j+1. Accordingly, the sample region labeled SRₖ₊₁ is associated with the data periods labeled DP₁ and DP₂ within cycle j+1. The sample region indices k can be assigned relative to time. For instance, the samples regions can be illuminated by the system output signal in the sequence indicated by the index k. As a result, the sample region SR₁₀ can be illuminated after sample region SR₉ and before SR₁₁.

The frequency output from the Complex Fourier transform represents the beat frequency of the composite signals that each includes a comparative signal beating against a reference signal. The beat frequencies from two or more different data periods that are associated with the same sample region can be combined to generate the LIDAR data. For instance, the beat frequency determined from DP₁ during the illumination of sample region SRₖ can be combined with the beat frequency determined from DP₂ during the illumination of sample region SRₖ to determine the LIDAR data for sample region SRₖ. As an example, the following equation applies during a data period where electronics increase the frequency of the outgoing LIDAR signal during the data period such as occurs in data period DP₁ of FIG. 5C: f_{ub}=−f_{d}+αᵤτ where f_{ub} is the frequency provided by the transform component, f_{d} represents the Doppler shift (f_{d}=2νₖf_{c}/c) where f_{c} represents the optical frequency (fₒ), c represents the speed of light, Vₖ is the radial velocity between the reflecting object and the LIDAR system where the direction from the reflecting object toward the chip is assumed to be the positive direction, c is the speed of light, and αᵤ represents a chirp rate (αₘ) for the data period where the frequency of the system output signal increases with time (α₁ in this case). The radial velocity can be a relative radial velocity since the LIDAR system and the object can both be in motion or the LIDAR system and/or the object can be stationary.

The following equation applies during a data period where electronics decrease the frequency of the outgoing LIDAR signal such as occurs in data period DP₂ of FIG. 5C: f_{db}=−f_{d}−α_{d}τ where f_{db} is a frequency provided by the transform component, and α_{d} represents the chirp rate (αₘ) for the data period where the frequency of the system output signal increases with time (α₂ in this case). In these two equations, f_{d} and τ are unknowns. These equations can be solved for the two unknowns and the electronics can then determine the radial velocity for sample region k (Vₖ) from the Doppler shift (Vₖ=c*f_{d}/(2f_{c})) and/or the separation distance for sample region k (Rₖ) can be determined from c*τ/2.

FIG. 5D illustrates a relationship between the data periods disclosed in FIG. 5C and the field of view for the LIDAR system. The field of view is defined by a collection of sample regions labeled SRₖ₋₁ through SRₖ₊₁. The LIDAR system outputs a system output signal that is scanned in the direction of the solid line labeled “scan.” The system output signal is scanned through a series of the sample regions (SRₖ₋₁ through SRₖ₊₁). The collection of sample regions that are scanned by the system output signal make up the field of view for the LIDAR system. Object(s) in the field of view can change with time. As a result, the locations of the sample regions are determined relative to the LIDAR system rather than relative to the environment and/or atmosphere in which the LIDAR system is positioned. For instance, the sample regions can be defined as being located within a range of angles relative to the LIDAR system. The dashed line labeled scan in FIG. 5D illustrates that the scan of the sample regions in the field of view can be repeated in multiple scan cycles. Accordingly, each scan cycle can scan the system output signal through the same sample regions when the objects in the field of view have moved and/or changed. The sample regions in the field of view can be scanned in the same sequence during different scan cycles or can be scanned in different sequences in different scan cycles.

The portion of each sample region that corresponds to one of the data periods are each labeled DP₁ or DP₂ in FIG. 5D. As is evident from FIG. 5C, the chirp rate during data period DP₁ is α₁ and the chirp rate during the data period DP₂ is α₂.

Each of the sample regions includes a dashed line labeled Lₖ. The dashed line labeled Lₖ can serve as a location reference line for sample region k. FIG. 5D includes location reference lines labeled Lₖ₋₁ through Lₖ₊₁. In FIG. 5D, each of the location reference lines (Lₖ) is drawn along the longitudinal axis of sample region with sample region index k.

FIG. 5D illustrate multiple orientation angles labeled θₖ where k represents the sample region index k. The orientation angle [symbol] ₖ can measure the angular orientation of sample region SRₖ relative to the LIDAR system. In some instances, the orientation angles θₖ are measured relative to the location reference lines Lₖ as shown in FIG. 5D. As a result, the orientation angles θₖ can measure the angular orientation of the location reference lines Lₖ. Because FIG. 5D illustrates the LIDAR system having a two-dimensional field of view, a single angle (θₖ) can define the angular orientation of sample region SRₖ relative to the LIDAR system; however, the field of view is often three dimensional. As a result, the LIDAR system can use two or more angles and/or other variables to define the orientation of a sample region relative to the LIDAR system.

FIG. 5E illustrates objects in the field of view disclosed in the context of FIG. 5D. For instance, two different objects located are located in the field of view of the LIDAR system. Each of the location reference lines (Lₖ) extends a distance Rₖ from the LIDAR system to a field location labeled flₖ. The distance Rₖ represents the value that the electronics determine for the distance between the LIDAR system and an object as a result of the system output signal transmitted during illumination of sample region SRₖ. As a result, the field location labeled flₖ can represent the location along the location reference line (Lₖ) where the electronics determine that a surface of an object that reflects the system output signal is located. The collection of field locations in the field of view can serve as a point cloud.

A possible source of errors in the calculation of the LIDAR data is evident from the illustration of FIG. 5E. The objects in the field of view are labeled object 1 and object 2. The movement of the system output signal during scanning causes the system output signal to go from being incident on object 1 during illumination of the sample region labeled SRₖ₋₁ to being incident on object 2 during illumination of the sample region labeled SRₖ. As a result, the system output signal is incident on different objects during a portion of data period DP₁ and a portion of data period DP₂. The change in the object that receives the system output signal during the illumination of sample region SRₖ can be a source of error in the LIDAR data that is generated for sample region SRₖ. As a result of this error, the field location labeled flₖ in FIG. 5E is not positioned at the surface while the field location labeled flₖ₋₁ is positioned at a surface of object 1 and the field location labeled flₖ₊₁ is positioned at a surface of object 2. Since the field location labeled flₖ is not positioned at a surface of an object, the LIDAR data associated with field location labeled flₖ is erroneous LIDAR data.

The source of the LIDAR data error illustrated in FIG. 5E results from the system output signal being incident on an edge of an object during the illumination of a sample region. As a result, the error can be considered an edge effect error. While the error is illustrated as occurring due to different objects, it can also occur with a single object. For instance, the error can also occur when scanning a system output signal across an edge of an object during the illumination of a sample region causes the system output signal to be incident on different surfaces of the object. FIG. 5F illustrates FIG. 5E modified so the detected edge is on a single object. As a result, an edge effect error can be a result of a perimeter edge as shown in FIG. 5E or an interior edge as shown in FIG. 5F.

The field locations (flₖ) that are associated with a distance, Rₖ, can also be associated with a radial velocity Vₖ where k represents that sample region index. The radial velocity Vₖ can be the radial velocity that the electronics generate for sample region with sample region index k.

The one or more orientation angle(s) (θₖ) and the distances Rₖ associated with each field location (flₖ) can effectively serve as polar coordinates or as spherical coordinates. As a result, the electronics can optionally convert the coordinates of the field locations flₖ to other coordinates systems including, but not limited to, Cartesian coordinates. As an example, FIG. 5G illustrates the field locations flₖ of FIG. 5F on the field of view of FIG. 5D labeled fl₁, fl₂, and fl₃. FIG. 5G shows field locations in addition to the field locations of FIG. 5F. Additionally, the axes of a Cartesian coordinate system are transposed on the field of view. As a result, the positions of the field locations flₖ are also shown relative to the Cartesian coordinate system. The electronics can optionally use the orientation angle (θₖ) and the distance Rₖ associated with each field location (flₖ) to convert the field location (flₖ) to the field positions labeled Pₖ shown in FIG. 5G. The collection of field positions in the field of view can serve as a point cloud.

In some instances, a field location (flₖ) is not present in all or a portion of the sample regions. For instance, when an object is not present in a sample region (SRₖ), a beating signal is not produced and LIDAR data is not generated for that sample region. As a result, a portion of the sample region indices may not be associated with a field location (flₖ). Accordingly, the associated field positions Pₖ may not be associated with coordinates, distance Rₖ, and/or radial velocity Vₖ. As a result, all or a portion of the sample region indices is associated with a field position (Pₖ), field location (flₖ), coordinates, distance Rₖ, and radial velocity Vₖ.

FIG. 5G labels the coordinates, distances Rₖ, and a radial velocities Vₖ and field locations associated with the field positions P₁, P₁, and P₃. FIG. 5G illustrates the coordinates as two-dimensional Cartesian coordinates (x,y) although three-dimensional coordinates and/or other coordinates systems are possible. In some instances, the coordinates are the polar coordinates or spherical coordinates of the field locations (flₖ).

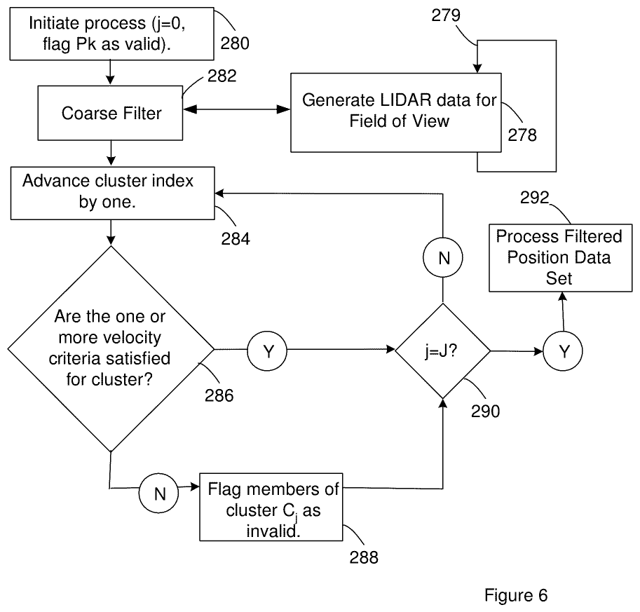

The electronics can process the position data for the field positions (Pₖ) in a field of view so as to correct for edge effect errors. FIG. 6 illustrates a process flow for a suitable process of addressing edge effect errors. At process block 278, the electronics generate the position data set for each of the fields of view that are scanned by the system output signal. For instance, the electronics can cause the system output signal to be scanned across the field of view. The electronics use the scan to generate the field position (Pₖ) coordinates, the associated distances (Rₖ) and radial velocities (Vₖ). As will be described below, a validity flag (fₖ) can also be associated with each of the field position (Pₖ) coordinates, the associated distances (Rₖ) and radial velocities (Vₖ). The field position (Pₖ) coordinates, the associated distances (Rₖ), radial velocities (Vₖ), and validity flags (fₖ) for a scanned field of view can serve as a position data set for the field of view. The position data set can be stored for later use. For instance, the electronics can include a memory in which the position data set can be stored.

As is evident from the arrow labeled 279, the electronics can repeat process block 278 after the scan of the field of view. As a result, the electronics cause the system output signal to repeatedly scan the field of view and generate and store the resulting position data sets from each scan of the field of view. Additionally, the electronics can process a field data set to reduce edge errors in parallel to generating the position data sets for one or more different fields of view.

At process block 280, the electronics can initiate the edge effect error correction process. For instance, the electronics can select one of the fields of view for which a position data set has been created. Additionally, the electronics can flag each of the field positions (Pₖ) in the position data set as valid. For instance, the electronics can set the validity flag (fₖ) associated with each of the field positions (Pₖ) in the position data to a value associated with validity. Additionally, the electronics can zero a cluster index j described in more detail below.

At process block 282, the electronics can optionally perform a coarse filter of the position data set. For instance, the position data associated with each of the field positions in the field of view can be compared to one or more coarse filter criteria. The one or more coarse filter criteria can be selected to indicate whether the position data for a field position is likely correct or incorrect. When the one or more filter criteria indicate that the position data for a field position is likely not correct, the electronics can discard from the position data set the position data for the field position. In contrast, when the one or more filter criteria indicate that the position data for a field position may be correct, the electronics can keep the position data for the field position in the position data set.

An example of a suitable filter criterion is whether the radial velocity (Vₖ) associated with a field position (Pₖ) has a magnitude above a velocity threshold (Vₜₕ). The velocity threshold (Vₜₕ) can be selected to represent a radial velocity that is unlikely to occur in the application of the LIDAR system. For instance, when the LIDAR system is used in a self-driving cars, a radial velocity with a magnitude above 200 mph is highly unlikely to occur. As a result, each of the field positions in a position data set with a radial velocity with a magnitude above 200 mph could be discarded from the position data set and each of the field positions in a position data set with a radial velocity magnitude less than or equal to 200 mph could be retained within the position data set. The velocity threshold (Vₜₕ) can be a function of the application of the LIDAR system. For instance, the velocity threshold (Vₜₕ) used in a LIDAR system for self-driving cars used on freeways would be higher than the velocity threshold (Vₜₕ) used in a LIDAR system for golf carts. Suitable velocity thresholds (Vₜₕ) used in a LIDAR system for self-driving cars include, but are not limited to, velocity thresholds (Vₜₕ) greater than or equal to 50 mph, 100 mph, or 150 mph and/or less than or equal to 200 mph, 300 mph, or 400 mph.

At process block 282, the electronics can apply a clustering algorithm to the field positions (Pₖ) in the accessed field of view so as to group the field positions (Pₖ) into J different clusters that each has a different cluster index j with a value from 1 to J. Each cluster can be represented by Cⱼ. The clusters are spatial clusters in that the field positions (Pₖ) within a cluster are positioned close to one another in the field of view and/or are located within an area of high field position density within the field of view. In general, a cluster is a function of the clustering algorithm used to identify the cluster and there are multiple different clustering algorithms available. In some instances, a portion of the field positions (Pₖ) in the field of view are not included in any of the clusters although it is possible for all of the field positions (Pₖ) in the field of view to be included in one of the clusters.

Because the clusters are spatial clusters, the clustering algorithm can be a distance-based clustering algorithm. Suitable clustering algorithms include, but are not limited to, automatic clustering algorithms such as centroid-based clustering algorithms, connectivity-based clustering algorithms, and density-based algorithms. In some instances, the clustering algorithms divide partition the field of view into multiple different partition regions. For instance, the clustering algorithm can be a KD-Tree clustering algorithm. As an example, the clustering algorithm can be a k-means clustering algorithm that uses the coordinates associated with the field positions to divide the field of view into a k-d tree. A k-means clustering algorithm iteratively identifies “J” center points (known as centroids) and then assigns field positions (Pₖ) to the closest centroid. The field positions (Pₖ) nearest the same centroid belong to the same cluster (Cⱼ).

The electronics can proceed from process block 284 to branch block 286 where the electronics apply one or more velocity criteria to the velocities (Vₖ) associated with the field positions (Pₖ) in the current cluster (Cⱼ). In some instances, the one or more velocity criteria are selected to identify clusters with radial velocities that have a high degree of variation. For instance, one or more velocity criteria can compare a measure of variance for the radial velocities of the field positions in the cluster to a variance threshold. As an example, the electronics can calculate the standard deviation of the radial velocities of the field positions in the cluster. The resulting standard deviation can be compare to the variance threshold. When the resulting standard deviation is less than or equal to the variance threshold, it can be determined that the one or more velocity criteria are satisfied at branch block 284. When the resulting standard deviation is greater than the variance threshold, it can be determined that the one or more velocity criteria are not satisfied at branch block 284.

When the electronics determine that the one or more velocity criteria are not satisfied at branch block 286, the electronics can proceed to process block 288. At process block 288, the electronics can flag the field positions (Pₖ) in the current cluster (Cⱼ) as invalid. For instance, the electronics can set the validity flag (fₖ) associated with each of the field positions (Pₖ) in the current cluster (Cⱼ) to a value associated with invalidity. As a result, at least portion of the field positions (Pₖ) in the cluster can become flagged as invalid in response to response to results from the application of the one or more velocity criteria to the velocities. However, when the electronics determine that the one or more velocity criteria are satisfied, at least a second portion of the field positions (Pₖ) in the cluster can remain flagged a valid as a result of the initial flagging of the field positions at process block 280. As a result, the second portion of the field positions (Pₖ) in the field of view can become flagged as valid in response to response to results from the application of the one or more velocity criteria to the velocities.

The electronics can proceed from process block 288 to branch block 290. Additionally, the electronics can proceed to branch block 290 when the electronics determine that the one or more velocity criteria are satisfied at branch block 286. At branch block 290, the electronics can make a determination whether each of the clusters in the field of view has been considered. For instance, the electronics can make a determination whether the cluster index j=J. When the determination at branch block 290 is negative, the electronics can return to process block 284.

When the determination at branch block 290 is positive, each of the clusters in the field of view has been tested for validity. As a result, at least a first portion of the field positions (Pₖ) in the field of view can be flagged as invalid in response to response to results from the application of the one or more velocity criteria to the velocities and/or at least a second portion of the field positions (Pₖ) in the field of view can be flagged as valid in response to response to results from the application of the one or more velocity criteria to the velocities. The distance Rₖ and/or radial velocity Vₖ associated with a field positions (Pₖ) can also be considered to be flagged as invalid when the field positions (Pₖ) is flagged as invalid. The distance Rₖ and/or radial velocity Vₖ associated with a field positions (Pₖ) can also be considered to be flagged as valid when the field positions (Pₖ) is flagged as valid. The position data set that results from testing the clusters in the field of view for validity can serve as a filtered position data set.

The electronics can proceed from process block 290 to process block 292. At process block 292, the electronics can process the filtered position data set and/or filtered LIDAR data results. For instance, the electronics can do further calculations using the data associated with the points in the filtered position data set (coordinates, distance, and radial velocity) and/or using the filtered LIDAR data results (coordinates, distance, and radial velocity). As an example, the electronics can do further processing of the filtered position data set in one or more different applications. The additional processing can use only data (one or more components selected from the group consisting of (coordinates, distance, and radial velocity) from field positions that are flagged as valid. For instance, the electronics can discard the data from field positions flagged as invalid and/or treat the data from field positions flagged as invalid as unavailable. An example of the LIDAR system treating data as not available for a sample region occurs when an object is not present in a sample region (SRₖ) so a beating signal is not produced and LIDAR data is not generated for that sample region. Examples of applications for which the electronics can process the filtered position data set include, but are not limited to, image generation, control of self-driving vehicles, point cloud generation, object recognition, statistical analysis, and predicting velocity and/or position of an object based on current and/or prior velocity and/or position of the object.

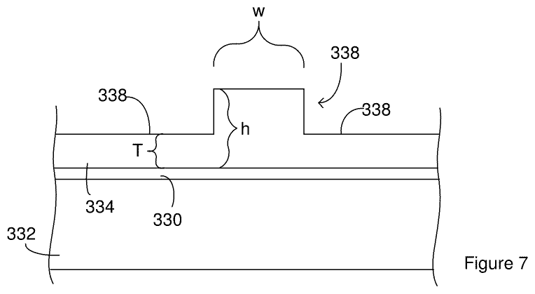

Suitable platforms for the LIDAR chips include, but are not limited to, silica, indium phosphide, and silicon-on-insulator wafers. FIG. 7 is a cross-section of portion of a chip constructed from a silicon-on-insulator wafer. A silicon-on-insulator (SOI) wafer includes a buried layer 330 between a substrate 332 and a light-transmitting medium 334. In a silicon-on-insulator wafer, the buried layer 330 is silica while the substrate 332 and the light-transmitting medium 334 are silicon. The substrate 332 of an optical platform such as an SOI wafer can serve as the base for the entire LIDAR chip. For instance, the optical components shown on the LIDAR chips of FIG. 1A through FIG. 1C can be positioned on or over the top and/or lateral sides of the substrate 332.

The electronics can serially repeat the method of FIG. 6. As the contents of the field of view change, the partition of the field of view can change. As a result, the partitioning of the field of view need not be constant over time. FIG. 6 illustrates processing of different partition in series. However, the portioning of the field of view can permit parallel processing. For instance, the electronics can concurrently select multiple partition regions to serve as one of the subject partition regions. The partitioned field positions in different partition regions can be concurrently processed.

As noted above, the partition of the field of view is optional. As a result, the field of view can serve as a single partition region that is processed according to the method disclosed in the context of FIG. 6. In these instances, the position data set can serve as the partitioned field positions within a single partition region. Accordingly, in these instances, the partitioned field positions discussed above can refer to field positions that are not partitioned.

The dimensions of the ridge waveguide are labeled in FIG. 7. For instance, the ridge has a width labeled w and a height labeled h. A thickness of the slab regions is labeled T. For LIDAR applications, these dimensions can be more important than other dimensions because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. The waveguide construction disclosed in the context of FIG. 7 is suitable for all or a portion of the waveguides on LIDAR chips constructed according to FIG. 1A through FIG. 1C.

Suitable electronics 32 can include, but are not limited to, a controller that includes or consists of analog electrical circuits, Application Specific Integrated Circuits (ASICSs), digital electrical circuits, processors, microprocessors, digital signal processors (DSPs), Field Programmable Gate Arrays (FPGAs), computers, microcomputers, or combinations suitable for performing the operation, monitoring and control functions described above. In some instances, the controller has access to a memory that includes instructions to be executed by the controller during performance of the operation, control and monitoring functions. Although the electronics are illustrated as a single component in a single location, the electronics can include multiple different components that are independent of one another and/or placed in different locations. Additionally, as noted above, all or a portion of the disclosed electronics can be included on the chip including electronics that are integrated with the chip.

Addressing the edge effect errors as disclosed above can be executed by the electronics 32. For instance, the process disclosed in the context of FIG. 6 can be executed by the electronics 32. In particular, addressing the edge effect errors as disclosed above can be executed by a Field Programmable Gate Array (FPGA), software, hardware, firmware, or a combination thereof.

Light sensors that are interfaced with waveguides on a LIDAR chip can be a component that is separate from the chip and then attached to the chip. For instance, the light sensor can be a photodiode, or an avalanche photodiode. Examples of suitable light sensor components include, but are not limited to, InGaAs PIN photodiodes manufactured by Hamamatsu located in Hamamatsu City, Japan, or an InGaAs APD (Avalanche Photo Diode) manufactured by Hamamatsu located in Hamamatsu City, Japan. These light sensors can be centrally located on the LIDAR chip. Alternately, all or a portion the waveguides that terminate at a light sensor can terminate at a facet located at an edge of the chip and the light sensor can be attached to the edge of the chip over the facet such that the light sensor receives light that passes through the facet. The use of light sensors that are a separate component from the chip is suitable for all or a portion of the light sensors selected from the group consisting of the first auxiliary light sensor 218, the second auxiliary light sensor 220, the first light sensor 223, and the second light sensor 224.

As an alternative to a light sensor that is a separate component, all or a portion of the light sensors can be integrated with the chip. For instance, examples of light sensors that are interfaced with ridge waveguides on a chip constructed from a silicon-on-insulator wafer can be found in Optics Express Vol. 15, No. 21, 13965-13971 (2007); U.S. Pat. No. 8,093,080, issued on Jan. 10, 2012; U.S. Pat. No. 8,242,432, issued Aug. 14, 2012; and U.S. Pat. No. 6,108,472, issued on Aug. 22, 2000 each of which is incorporated herein in its entirety. The use of light sensors that are integrated with the chip are suitable for all or a portion of the light sensors selected from the group consisting of the auxiliary light sensor 218, the second auxiliary light sensor 220, the first light sensor 223, and the second light sensor 224.

The light source 4 that is interfaced with the utility waveguide 12 can be a laser chip that is separate from the LIDAR chip and then attached to the LIDAR chip. For instance, the light source 4 can be a laser chip that is attached to the chip using a flip-chip arrangement. Use of flip-chip arrangements is suitable when the light source 4 is to be interfaced with a ridge waveguide on a chip constructed from silicon-on-insulator wafer. Alternately, the utility waveguide 12 can include an optical grating (not shown) such as Bragg grating that acts as a reflector for an external cavity laser. In these instances, the light source 4 can include a gain element that is separate from the LIDAR chip and then attached to the LIDAR chip in a flip-chip arrangement. Examples of suitable interfaces between flip-chip gain elements and ridge waveguides on chips constructed from silicon-on-insulator wafer can be found in U.S. Pat. No. 9,705,278, issued on Jul. 11, 2017 and in U.S. Pat. No. 5,991,484 issued on Nov. 23, 1999; each of which is incorporated herein in its entirety. When the light source 4 is a gain element or laser chip, the electronics 32 can change the frequency of the outgoing LIDAR signal by changing the level of electrical current applied to through the gain element or laser cavity.

The above LIDAR systems include multiple optical components such as a LIDAR chip, LIDAR adapters, light source, light sensors, waveguides, and amplifiers. In some instances, the LIDAR systems include one or more passive optical components in addition to the illustrated optical components or as an alternative to the illustrated optical components. The passive optical components can be solid-state components that exclude moving parts. Suitable passive optical components include, but are not limited to, lenses, mirrors, optical gratings, reflecting surfaces, splitters, demultiplexers, multiplexers, polarizers, polarization splitters, and polarization rotators. In some instances, the LIDAR systems include one or more active optical components in addition to the illustrated optical components or as an alternative to the illustrated optical components. Suitable active optical components include, but are not limited to, optical switches, phase tuners, attenuators, steerable mirrors, steerable lenses, tunable demultiplexers, tunable multiplexers.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A system, comprising:
a LIDAR system configured to output a system output signal, scan the system output signal through a series of sample regions, and generate LIDAR data results for the sample regions,
the LIDAR data result for each of the sample regions indicating a radial velocity and/or a distance between the LIDAR system and an object in the sample region;
electronics configured to generate a point cloud such that each point in the point cloud is associated with a velocity and a distance of the point from the LIDAR system,
generation of the point cloud including calculating the velocities and the distances associated with the points;
the electronics configured to apply a clustering algorithm to the points in the point cloud so as to group at least a portion of the points into multiple different spatial clusters;
the electronics configured to apply one or more velocity criteria to the velocities associated with at least a portion of the points;
the electronics configured to flag a portion of a points as valid in response to results from he application of the one or more velocity criteria to the velocities and also to flag a second portion of the points as invalid in response to results from the application of the one or more velocity criteria to the velocities,
the velocity criteria being selected such that the points flagged as invalid include points generated from sample regions where the system output signal is incident on an edge of the object in the sample region; and
the electronics configured to removing from the point cloud the points flagged as invalid so as to generate a filtered point cloud.

2. The system of claim 1, wherein the velocities are radial velocities.

3. The system of claim 1, wherein application of the one or more velocity criteria to the points in a subject one of the clusters includes calculating the standard deviation of the velocities associated with the points in the subject cluster.

4. The system of claim 3, wherein application of the one or more velocity criteria to the points in the subject cluster includes comparing the standard deviation to a threshold.

5. The system of claim 4, wherein the points in the subject cluster are flagged as invalid in response to the standard deviation being above the threshold.

6. The system of claim 4, wherein the points in the subject cluster are flagged as valid in response to the standard deviation being above the threshold.

7. The system of claim 1, wherein the clustering algorithm is a k-means clustering algorithm.

8. The system of claim 7, wherein the clustering algorithm is a KD-tree clustering algorithm.

9. The system of claim 1, wherein application of the clustering algorithm includes partitioning of the field of view into multiple partition regions.

10. The system of claim 1, wherein the electronics are configured to operate the LIDAR system such that the LIDAR system stores the filtered point cloud in a memory.

11. The system of claim 1, wherein the clustering algorithm is a spatial clustering algorithm.

12. The system of claim 1, wherein removal from the point cloud the points flagged as invalid so as to generate a filtered point cloud includes performing calculations on the points in the filtered point cloud.

13. The system of claim 12, wherein performance of the calculations on the points in the point cloud is performed such that the points flagged as invalid are excluded from the calculations but the points flagged as valid are included in the calculations.
